(19) United States
(12) Patent Application Publication
(10) Pub. No.: US 2005/0113525 A1
(43) Pub. Date: May 26, 2005

(54) Use of tetrafunctional initiators to improve the rubber phase volume of HIPS

(76) Inventors: Jose M. Sosa, Deer Park, TX (US); Kenneth Paul Blackmon, Houston, TX (US)

Correspondence Address: FINA TECHNOLOGY INC, PO BOX 674412, HOUSTON, TX, 77267-4412, US

(21) Appl. No.: 10/723,656

(22) Filed: Nov. 26, 2003

(51) Int. Cl. C08F 4/00; C08F 253/00

(52) U.S. Cl. 525/263; 526/346; 525/244

(57) ABSTRACT

It has been discovered that improved polystyrene products, such as high impact polystyrene (HIPS), may be obtained by polymerizing styrene with a diene polymer in the presence of at least one multifunctional initiator. The presence of the multifunctional initiator tends to cause more branched structures in the polystyrene. Unexpectedly, the ratio of % gel to % rubber (G/R or rubber phase volume) increases as the swell index increases which is the opposite of the conventional trend. Additionally, acceptable G/R values can be achieved at increased polymerization rates with these initiators.

### FIELD OF THE INVENTION

The present invention is related to methods and compositions useful to improve the manufacture of copolymers of vinyl aromatic monomers such as styrene. It relates more particularly to methods of copolymerizing vinyl aromatic monomers with multifunctional initiators in the presence of diene polymers.

### BACKGROUND OF THE INVENTION

The polymerization of styrene is a very important industrial process that supplies materials used to create a wide variety of polystyrene-containing articles. This expansive use of polystyrene results from the ability to control the polymerization process. Thus, variations in the polymerization process conditions are of utmost importance since they in turn allow control over the physical properties of the resulting polymer. The resulting physical properties determine the suitability of polystyrene for a particular use. For a given product, several physical characteristics must be balanced to achieve a suitable polystyrene material. Among the properties that must be controlled and balanced are average molecular weight (Mw) of the polymer, molecular weight distribution (MWD), melt flow index (MFI), and the storage modulus (G′). For rubber toughened materials, such as high impact polystyrene, which is composed of rubber particles in a polystyrene matrix, factors that influence rubber morphology, such as rubber particle size, rubber particle size distribution, swell index, grafting, and the rubber phase volume, as measured by the ratio of the % gel to % rubber (G/R), are also critical to balance physical and mechanical properties.

Methods for preparing branched polymers are well-known in the art. For example, the preparation of branched polystyrene by free radical polymerization has been reported in various patents. The polymerization of branched polystyrenes in the presence of elastomers to produce HIPS, however, presents various challenges, since branching reactions can lead to crosslinking of the matrix and also of the rubber phase.

A wide variety of peroxy compounds is known from the literature as initiators for the production of styrenic polymers. Commercially available initiators for polymer production may be classified in different chemical groups, which include diacylperoxides, peroxydicarbonates, dialkylperoxides, peroxyesters, peroxyketals, and hydroperoxides.

Mono- and bifunctional peroxide initiators are commonly used in the manufacture of rubber-modified polystyrene (PS), and peroxides have been used to increase the rate of polymerization and to modify the degree of chemical grafting between polystyrene and the elastomer (typically polybutadiene rubber) used to modify PS. Increasing the rate of polymerization by using initiators causes the molecular weight of the PS matrix to decrease; chemical grafting may or may not increase depending on the levels and the temperature at which the initiator is used. Thus, the use of initiators to manufacture high impact polystyrene (HIPS) requires an optimization of rate, temperature, molecular weight, chemical grafting, as well as other parameters.

Commercial polystyrene made by the conventional free-radical process yields linear structures. As noted, methods to prepare branched polystyrenes, however, are not easily optimized and few commercial non-linear polystyrenes are known. Studies of branched polymers show that these polymers possess unique molecular weight-viscosity relationships due to the potential for increased molecular entanglements. Depending upon the number and length of the branches, non-linear structures can give melt strengths equivalent to that of linear polymers at slightly higher melt flows.

U.S. Pat. No. 6,353,066 to Sosa describes a method of producing a copolymer by placing a vinylbenzene (e.g. styrene) in a reactor, placing a cross-linking agent (e.g. divinylbenzene) in the reactor, and placing a chain transfer agent (e.g. mercaptan) in the reactor and forming a polyvinylbenzene in the presence of the cross-linking agent and chain transfer agent.

It would be desirable if methods could be devised or discovered to provide vinylaromatic polymers with increased branching, such as branched polystyrene for the manufacture of HIPS. It would also be helpful if a method could be devised that would help optimize the physical properties of rubber-toughened vinylaromatic polymers having increased branching, while maintaining production rates and molecular weight properties. Such materials may have a higher melt strength than those having linear chains, and may improve processability and mechanical properties of the final product.

### SUMMARY OF THE INVENTION

There is provided, in one form, a method for producing an improved copolymerized product that involves copolymerizing at least one vinylaromatic monomer with at least one diene polymer in the presence of at least one multifunctional initiator. The multifunctional initiator may be a trifunctional or tetrafunctional peroxide. A copolymerized product is recovered that has a ratio of % gel to % rubber (G/R or rubber phase volume) that increases as swell index increases.

In another embodiment of the invention, there is provided an improved copolymerized product made by copolymerizing at least one vinylaromatic monomer with at least one diene polymer in the presence of at least one multifunctional initiator. The multifunctional initiator may be a trifunctional or tetrafunctional peroxide. A copolymerized product is recovered that has a G/R that increases as swell index increases.

In still another embodiment of the invention, there is a resin that includes at least one vinylaromatic monomer, at least one diene polymer, and at least one multifunctional initiator. The multifunctional initiator is either a trifunctional or tetrafunctional peroxide, and the amount of multifunctional initiator is sufficient to produce a copolymerized product that has a G/R that increases as swell index increases.

In yet another embodiment of the invention, there are provided articles made from the resins and copolymerized products of this invention.

### BRIEF DESCRIPTION OF THE DRAWINGS

FIG. 1 is a graph of % polystyrene v. time in hours for equivalent peroxide functionalities, where the feed is styrene;

FIG. 2 is a graph of % polystyrene v. time in hours for equivalent peroxide functionalities, where the feed is styrene but contains 7% Diene 55;

FIG. 3 is a graph of Mw in thousands as a function of % conversions for isothermal polymerization at 110° C. for equivalent peroxide functionalities;

FIG. 4 is a plot of % solids as a function of time for various levels of JWEB 50 tetrafunctional initiator for a feed of styrene including 4% Bayer 380;

FIG. 5 is a plot of G/R ratio v. swell index for commercial FINA HIPS materials; and

FIG. 6 is a plot of gel/rubber ratio vs. swell index for experiments with tetrafunctional initiator (JWEB50) and various commercial grades.

### DETAILED DESCRIPTION OF THE INVENTION

The inventors have explored the potential for providing branched polystyrene having at least some increased branching by using tetrafunctional initiators or trifunctional initiators. The invention concerns initiating polymerization of a vinyl aromatic monomer such as styrene in various solvents and in the optional presence of a polydiene, such as polybutadiene, with a multifunctional initiator (e.g. tri- or tetrafunctional) and to use the multifunctional initiator to obtain branched structures.

For conventional HIPS resins, the rubber phase volume is a key parameter that can be estimated from solution properties. The rubber phase volume refers to the rubber particles or discontinuous phase, which consists of rubber, trapped polystyrene (occlusions) and grafted polymer. A convenient way to classify HIPS materials is by calculating the dry gel obtained for a given rubber level. For commercial HIPS materials, the gel/rubber ratio (G/R) can vary from 1 to 4 for swell indices of 10-12, and as the swell index increases the G/R ratio decreases. The G/R ratio is the ratio of the % gel to % rubber, and is also termed the rubber phase volume (RPV). This ratio, the G/R, is important in the manufacture of HIPS materials because it represents the “rubber efficiency” of the process, i.e., how much rubber must be used to obtain similar product quality. The less rubber needed to produce a set of desired properties in a HIPS material, the more efficient the process. The G (percent gel) is measured by first dissolving the resin in toluene, separating the gel fraction by centrifugation, and then drying the wet gel. The percent gel is then calculated from this dried residue by the formula: Percent Gel=100 .times.dried gel weight, divided by the initial weight of the sample. The percent rubber is measured by the well-known Iodine Monochloride (I-Cl) titration method.

It has been surprisingly discovered herein that contrary to conventional HIPS resins, with multifunctional peroxide initiators, the opposite trend is seen, that is as the level of multifunctional initiator is increased, G/R increases even though the swell index of these materials is very high.

Generally, for this invention, the G/R increases from about 1 to about 4 as the swell index increases from about 8 to about 20. Alternatively, in another non-limiting embodiment of the invention, the G/R ranges from about 1 to about 3 while the swell index ranges from about 12 to about 20. In one particular non-limiting embodiment of the invention, the G/R ranges from about 1.5 to about 3.0 while the swell index ranges from about 10 to about 14. This unexpected phenomenon is discussed further with respect to the data below.

In one non-limiting embodiment of the invention, the melt flow index (MFI) for the resins of this invention range from about 2 to about 7. In another non-limiting embodiment of the invention, the MFI range from about 3 to about 5.

In theory, tetrafunctional materials can be schematically represented by the shape of a cross. If at the end of each arm of the cross, the potential for initiation or chain transfer exists, it is possible to envision polystyrene molecules that will have higher molecular weight than by using bifunctional initiators only. Similarly to tetrafunctional initiators, trifunctional initiators simply have three “arms” or starting points instead of the four found in tetrafunctional initiators.

In the present case, relatively small levels of the tetrafunctional initiators are used to optimize the melt properties resulting from the formation of branched structures. With the tetrafunctional initiator, four linear chains for one branched molecules are formed. At high levels of initiators the amount of linear chains, initiated by the alkyl radicals, will lower the effect brought by the branched chains, initiated by the tetrafunctional radicals. Further, multifunctional peroxides can be used to increase polymerization rates and chemical grafting, while maintaining or increasing PS matrix molecular weight. The potential use of these multifunctional initiators in the production of HIPS allows higher production rates while maintaining molecular weights and improving rubber phase volume.

The composition of the invention can include a polydiene-modified monovinyl aromatic polymer, and can include a rubber (polybutadiene)-modified polystyrene. Styrene monomer can be polymerized in the presence of from about 2 to about 15 weight percent rubber to produce a copolymer having impact resistance superior to that of polystyrene homopolymer. A rubber that can be used in making the subject compositions is polybutadiene. The resultant thermoplastic composition, which can be made with these materials, is high impact polystyrene, or HIPS. The predominant morphology of the polymer made from embodiments of the invention is cell or “salami” with some core-shell structure, meaning that the continuous phase of polystyrene comprises a plurality of dispersed structures in which polystyrene is trapped within rubber particles having a distinct membrane and small quantities of polystyrene are occluded inside single cell polybutadiene shells grafted to the aromatic polymer.

Styrene polymerization processes are well known. The compositions of the invention can be made by batch polymerization in the presence of from about 2 to 15, and in some embodiments can be from about 4 to about 12, weight percent polybutadiene using multifunctional initiators at concentrations of from about 50 to about 1200 ppm and using a solvent. In another non-limiting embodiment of the invention the concentration of multifunctional initiator may range from about 100 to about 600 ppm.

For comparison, monofunctional and bifunctional initiators are also used in the Examples of this Description. The structures of some of the initiators are shown below:

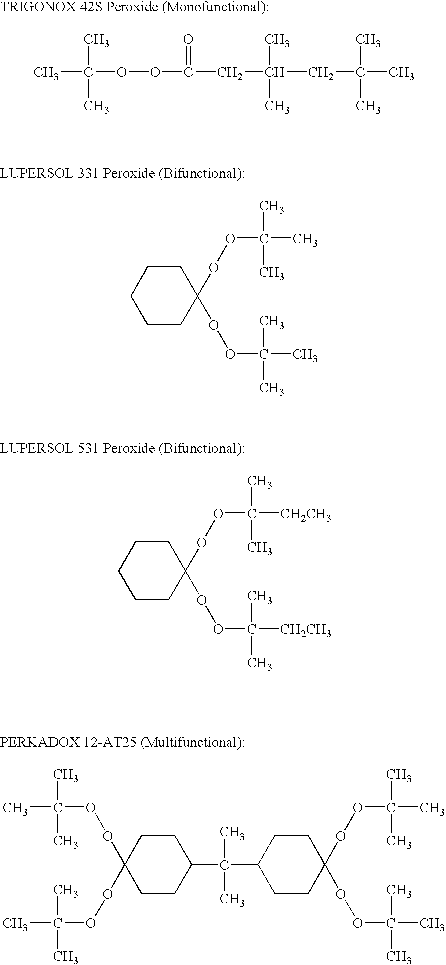

In one non-limiting embodiment of the invention, the multifunctional initiator is a trifunctional or tetrafunctional peroxide and is selected from the group consisting of tri- or tetrakis t-alkylperoxycarbonates, tri- or tetrakis-(t-butylperoxycarbonyloxy) methane, tri- or tetrakis-(t-butylperoxycarbonyloxy)butane, tri- or tetrakis(t-amylperoxycarbonyloxy)butane, tri- or tetrakis(t-C₄₋₆ alkyl monoperoxycarbonates) and tri- or tetrakis(polyether peroxycarbonate), and mixtures thereof. In one non-limiting embodiment of the invention, the tetrafunctional initiator has four t-alkyl terminal groups, where the t-alkyl groups are t-butyl and the initiator has a poly(methyl ethoxy) ether central moiety with 1 to 4 (methyl ethoxy) units. This molecule is designated herein as LUPEROX® JWEB 50 and is available from Atofina Petrochemicals, Inc. Another commercial product suitable as a multifunctional initiator is 2,2 bis(4,4-di-(tert-butyl-peroxy-cyclohexyl)propane) from Akzo Nobel Chemicals Inc., 3000. South Riverside Plaza Chicago, Ill., 60606. Another commercial product is 3,3′,4,4′ tetra(t-butyl-peroxy-carboxy)benzophenone from NOF Corporation Yebisu Garden Place Tower, 20-3 Ebisu 4-chome, Shibuya-ku, Tokyo 150-6019.

Monofunctional peroxide initiators can undergo homolytic cleavage to produce monoradicals, each of which can initiate a chain. Bifunctional initiators, depending on the breakdown patterns, can cause chain extension if biradical formation is possible from a fragment. Tri- and tetrafunctional initiators can also cause chain extension. Because of the possible and various complex decomposition patterns, it is not easy to determine a prior how a given initiator will decompose under a given set of conditions; however, by measuring the molecular weight of the resultant polymer, it is possible to determine if the initiators are able to produce chain extension.

Suitable optional solvents for the polymerization include, but are not necessarily limited to ethylbenzene, xylenes, toluene, hexane and cyclohexane. Chain transfer agents and crosslinking agents can be used in applications of this invention as taught by art.

It has been discovered that multifunctional initiators can be used together with chain transfer agents and cross-linking agents to manufacture polystyrene and HIPS that is more highly branched. The chain transfer agent and/or cross-linking agent may be added prior to, during or after the initiator is added to the monomer.

It has also been discovered that the polymerization of a vinyl aromatic monomer such as styrene carried out in the presence of divinylbenzene (DVB) and n-dodecyl mercaptan (NDM) to produced branched structures as disclosed in U.S. Pat. No. 6,353,066 (incorporated by reference herein) can be improved by using a tetrafunctional initiator in combination with DVB and NDM. Extensive studies have been done to determine the conditions suitable for optimizing the melt rheology, however, it has been surprisingly found that an increase in rate can be produced while obtaining the desired molecular parameters.

Grafting is also favored by using polybutadiene having a medium or high-cis isomer content. Polybutadiene useful in making the composition of the invention is produced, for example, by known processes by polymerizing butadiene in either a hexane or cyclohexane solvent to a concentration of about 12 weight percent, and flashing off the solvent at a temperature ranging from about 80° to 100° C. to further concentrate the polybutadiene solution to about 24 to 26 weight percent, the approximate consistency of rubber cement. The polybutadiene is then precipitated from the solution as a crumb using steam, then dried and baled. Commercially available rubbers suitable for producing HIPS are available from several suppliers such as Bayer 380, 550, and 710 (Bayer Corporation, Orange, Tex.) and Firestone Diene 35, 55 and 70 (Firestone Polymers, Akron, Ohio).

In one non-limiting embodiment of the invention, the copolymerized products of this invention may have a polydispersity of from about 2.2 to 4.5. In another non-limiting [preferred] embodiment, the copolymerized products of this invention may have a polydispersity ranging from about 2.3 to 4.0. In another non-limiting embodiment the polydispersity may range from about 2.3 to 3.2.

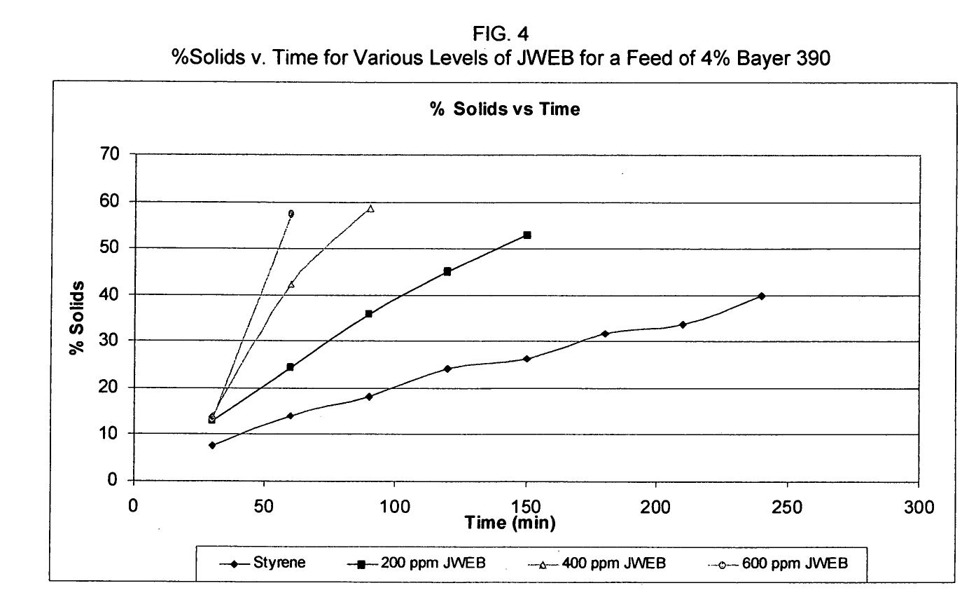

Not only has it been surprisingly discovered that G/R increases as the swell index increases using the multifunctional initiators of this invention, but it has also been found that acceptable G/R can be achieved at increased polymerization rates using these initiators in polymerizations of styrene. The rate of polymerization styrene is about 10%/hr at 130° C. from 10 to about 50% solids (no initiator). As the level of JWEB increases, the rate (slope of the line) can be increased by a factor of 2 to 7 times that of pure styrene (no initiator) in the range of 10 to 50% PS conversion as the level of initiator increases. Compared to pure styrene, the slopes are 2.3, 4.3 and 6.6 times that of pure styrene for 200, 400 and 600 PPM of JWEB, respectively as will be seen in FIG. 4.

In making the certain compositions of the invention, batch or continuous polymerizations can be conducted in 97:3 to 91:9 styrene to rubber, 85:15 to 80:20 typical styrene solvent mixtures to 60-80% styrene conversion to polystyrene and then flashing off the unreacted monomer and the solvent. In a non-limiting, typical preparation, 3-12% of rubber is dissolved in styrene, then about 10% ethylbenzene is added as 90:10 styrene:ethylbenzene. The ethylbenzene is used as a diluent. Other hydrocarbons can also be used as solvents or diluents. A possible temperature profile to be followed in producing the subject compositions is about 110° C. for about 120 minutes, about 130° C. for about 60 minutes, and about 150° C. for about 60 minutes, in one non-limiting embodiment. The polymer is then dried and devolatilized by conventional means. Although batch polymerizations are used to describe the invention, the reactions described can be carried out in continuous units, as the one described by Sosa and Nichols in U.S. Pat. No. 4,777,210, incorporated by reference herein. In another non-limiting embodiment of the invention, the copolymerizing may be conducted at a temperature between about 80° C. to about 200° C.; in an alternate embodiment of the invention from about 110° C. to about 180° C.

It will be appreciated that other components may be added during or prior to the polymerizations described herein that would be within the scope of the invention. Such components include, but are not necessarily limited to, chain transfer agents, cross-linking agents, accelerators, lubricants, and diluents and the like.

The invention will now be described further with respect to actual Examples that are intended simply to further illustrate the invention and not to limit it in any way.

Studies have been done to determine the conditions suitable for optimizing the melt rheology of a branched polystyrene system using multifunctional initiators, however it has also been surprisingly discovered that an increase in rate can be obtained while producing the desired molecular parameters, particularly an improvement in the gel to rubber ratio. Laboratory polymerization studies were conducted using the peroxide initiators described in Table I. The structural representations for some of these peroxides were given previously.

TABLE I
Initiators Used in Styrene Polymerization Studies

| Peroxide | Class | Type | 1 hr. T_{1/2}, ° C. |
|---|---|---|---|
| TRIGONOX 42S | Peroxyester | Monofunctional | 110 |
| LUPERSOL 331 | Peroxyketal | Bifunctional | 112 |
| LUPERSOL 531 | Peroxyketal | Bifunctional | 112 |
| PERKADOX | Peroxyketal | Multifunctional | 112 |
| 12-AT25 | | | |
| JWEB 50 | Peroxyketal | Multifunctional | 119 |
| | | | (in ethylbenzene) |
| | | | 121 |
| | | | (in dodecane) |

The first four initiators were chosen for study due to their similarities in half-life temperatures and differences in peroxide functionalities. The polymerizations were performed isothermally (110° C.), as well as non-isothermally (temperature ramp process), for both crystal and HIPS systems. Further, initiator concentrations were varied to assess rate and molecular weight effects.

Isothermal Polymerization Studies—Crystal Polystyrene

Isothermal polymerizations were conducted at 110° C. to monitor conversion and molecular weight as a function of reaction time. The chosen reaction temperature of 110° C. is essentially that of the one-hour half-life temperatures of the initiators. The polymerization rate increased with increasing initiator concentration [I], generally following the expected square root relationship.

From the well-known kinetic expressions, the degree of polymerization (molecular weight) is inversely proportional to the rate of polymerization. The molecular weight decreased with increasing initiator concentration. Further, the molecular weight obtained at a given initiator concentration becomes relatively constant after 20-30% conversion.

The molecular weight behavior for styrene polymerization using bifunctional initiators (LUPERSOL 331, LUPERSOL 531) was different. Initially, a decrease in polymer molecular weight was obtained with increased initiator concentration due to increased polymerization rate. However, rather high molecular weights were seen at higher conversions. Several researchers have attributed this molecular weight enhancement to “chain-extension” polymerization. Basically, the high molecular weight is due to the initiation of undecomposed peroxides on the polymer chain ends, followed by chain propagation reactions. Thus, the polymerization characteristics observed for the bifunctional initiator systems indicate that both high rates and molecular weights can be obtained simultaneously. Such a desirable rate/molecular weight relationship is even more evident with the tetrafunctional initiator (PERKADOX 12-AT25). It was seen that the polymerization rates and polymer molecular weights were significantly higher than those from the bifunctional systems.

The bifunctional initiators yielded a significantly higher polymerization rate than did the monofunctional initiator, but similar molecular weights (at conversions of greater than 35%). The tetrafunctional initiator gave an extremely rapid polymerization rate and superior molecular weights when compared to the bifunctional peroxides. Similar effects were noted when the initiators are compared on an equi-peroxide functionality basis.

Non-Isothermal Polymerization Studies—Crystal PS

Non-isothermal polymerization studies were conducted to assess the effects of initiator type/functionality on crystal PS properties, particularly on molecular weight. The reaction profile was 2 hours at 110° C., 1 hour at 130° C., 1 hour at 150° C., followed by devolatilization at 240° C. for 0.5 hours (<2 mmHg; <267 Pa).

A tetrafunctional initiator gave a significantly higher polymerization rate than did any of the other peroxides. LUPERSOL 531, a t-amyl peroxyketal, yielded a more rapid rate than does the t-butyl derivative (LUPERSOL 331). Interestingly, the tetrafunctional initiator yielded the highest molecular weight crystal PS (about 20% higher Mw). The higher molecular weight fraction obtained, however, led to an increased polydispersity (about 3.5). The bifunctional initiators yielded similar molecular weights and higher rates than does the monofunctional peroxide. Similar results were obtained when the initiators are compared on an equi-peroxide functionality basis. The results further supported the mechanism of polymer chain extension via decomposition of end-group peroxides, followed by propagation.

Non-Isothermal Polymerization Studies—HIPS

Laboratory HIPS materials were prepared with the initiators using 7% Diene 55 via a temperature ramp process. Diene 55 is a polybutadiene available from Firestone Polymers. The results were similar to those obtained in the crystal PS polymerization studies. A rapid polymerization rate was obtained with the tetrafunctional peroxide; however, the resulting “pellet” molecular weight (particularly Mw) was still quite high. Again, a broadening of the molecular weight distribution was noted. Further, it is seen that the bifunctional initiators also lead to superior polymerization rate/molecular weight relationships when compared to the monofunctional peroxide. The advantages of the tetrafunctional initiator in terms of molecular weight were readily apparent.

TABLE II
Comparison of Molecular Weights and Polydispersities
for PS and HIPS Products with Different Initiators

| Feed | Parameter | Lup 331 | Lup 531 | Perk 12 | Trig 42S |
|---|---|---|---|---|---|
| Example | | 1 | 2 | 3 | 4 |
| Styrene | Mn in thousands | 82 | 100 | 100 | 75 |
| | Mw in thousands | 250 | 256 | 352 | 220 |
| | Polydispersity | 3.0 | 2.6 | 3.5 | 2.9 |
| Example | | 5 | 6 | 7 | 8 |
| 7% Diene 55 | Mn in thousands | 92 | 110 | 100 | 110 |
| | Mw in thousands | 250 | 260 | 320 | 240 |
| | Polydispersity | 2.7 | 2.4 | 3.2 | 2.2 |

The effects of initiator type and concentration on rubber phase properties must also be considered; these results are given in Table IV. In these Examples, the amount of rubber is dependent on the conversion in the fourth series reactor, i.e. no recycle. Note that polydispersities for the multifunctional initiators Perk 12 and Trig 42S range from 2.2 to 3.2.

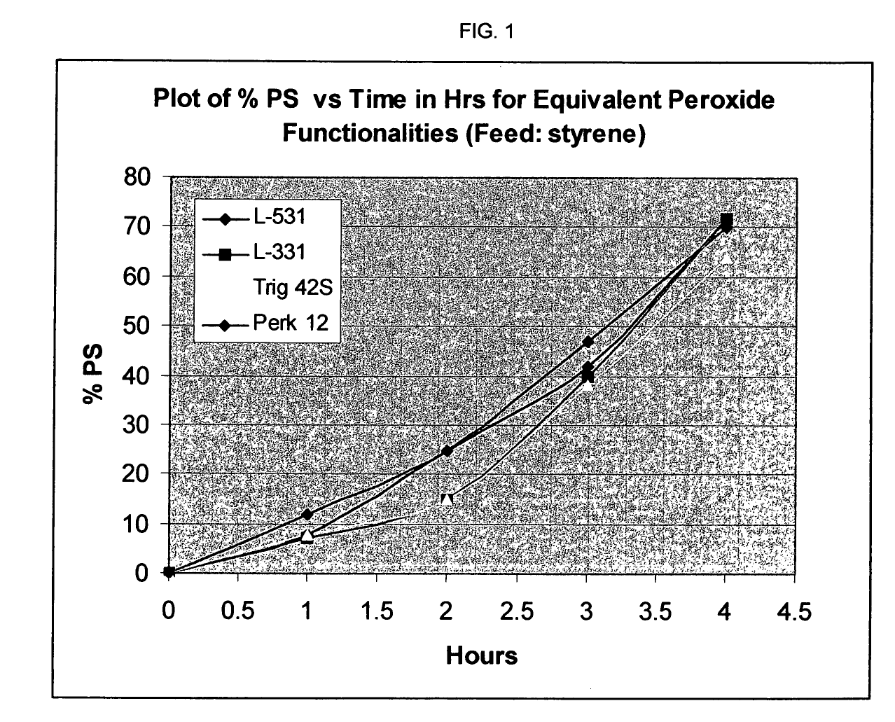

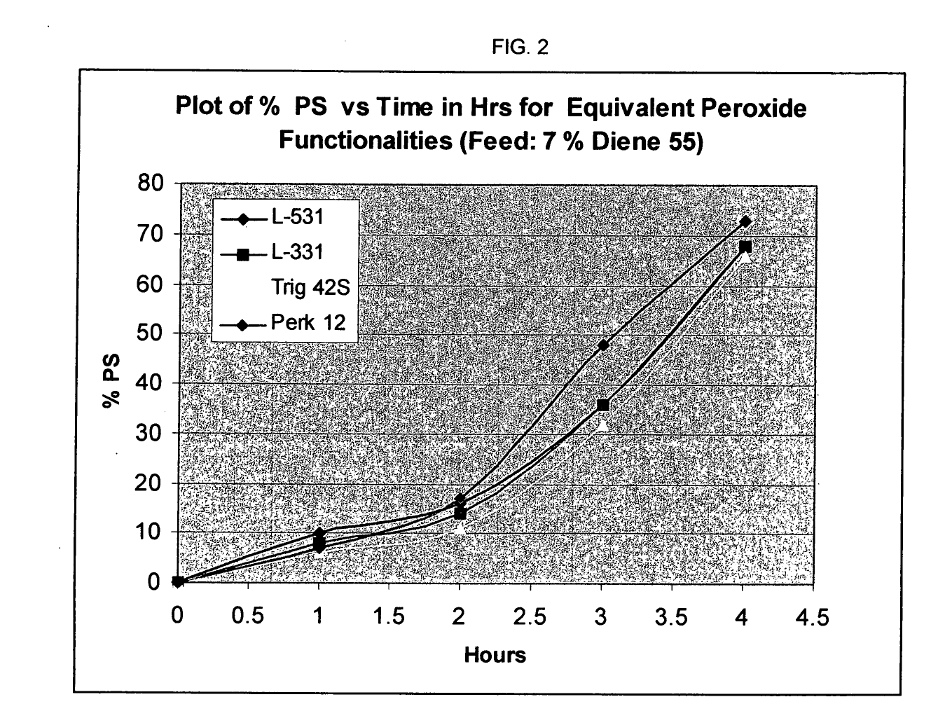

FIG. 1 presents graphs of % polystyrene as a function of time for equivalent peroxide functionalities for the four initiators of Table II where the feed is styrene, such as for Examples 14. Generally, the plots are roughly equivalent. FIG. 2 provides plots of % polystyrene as a function of time for equivalent peroxide functionalities for the four initiators of Table II where the feed is styrene and 7% Diene 55, such as for Examples 5-8. Again the results are comparable except that after about two hours the % polystyrene for Perkadox 12-AT25 is somewhat higher. The data in FIGS. 1 and 2 are from ramp processes.

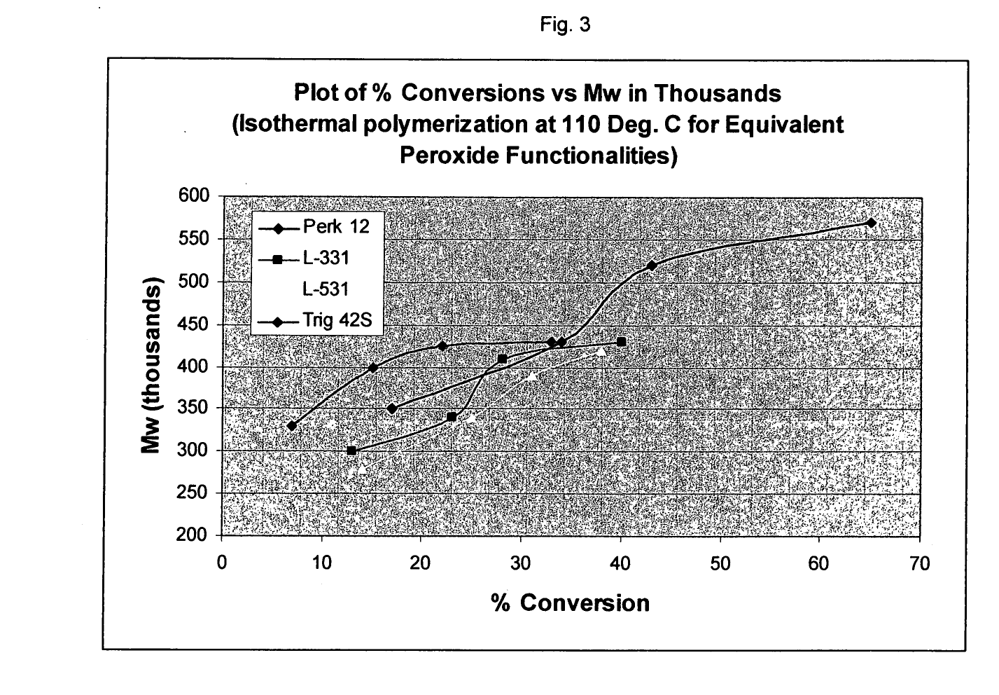

FIG. 3 is a plot of Mw (in thousands) as a function of % conversion for isothermal polymerization at 110° C. for equivalent peroxide functionalities for the four initiators of Table II. Interestingly, the monofunctional Trigonox 42S gave relatively lower conversions and somewhat higher molecular weights as compared with the bifunctional Lupersol initiators. The multifunctional Perkadox 12-AT25 provided relatively higher conversions and higher Mw indicative of the greater functionality.

FIG. 4 is a plot of % solids vs. time for various levels of JWEB 50 tetrafunctional initiator for a styrene feed having 4% Bayer 390 rubber. It may be seen that as the amount of JWEB 50 tetrafunctional initiator is increased, the steeper the plot of % solids v. time indicating rapid polymerization with increasing tetrafunctional initiator. Molecular weight data for polymerizations conducted using JWEB 50 tetrafunctional initiator are summarized in Table III, below. An initiator proportion of 400 ppm JWEB gave a polymerization rate of about 4.3 times that of thermal polymerization in the absence of peroxide, while a level of 600 ppm JWEB gave a polymerization rate of about 6.6 times that of pure styrene. These rates are very unusual, particularly considering that acceptable G/R values are obtained. It may also be seen that Mp decreases and Mz increases with increasing initiator proportion in Table III.

TABLE III
Summary of Mol. Wt. Data for Polymerizations with JWEB-50

| Ex. | Sample | Mn | Mw | Mp | Mz | Mz + 1 | MWD |
|---|---|---|---|---|---|---|---|
| 9 | 4% Bayer 380 | 133145 | 323895 | 329801 | 497270 | 667047 | 2.43 |
| 10 | 200 ppm JWEB | 140409 | 327845 | 302749 | 535576 | 784150 | 2.33 |
| 11 | 400 ppm JWEB | 134609 | 326436 | 273374 | 586097 | 926299 | 2.43 |
| 12 | 600 ppm JWEB | 115929 | 320599 | 256155 | 625938 | 1046255 | 2.76 |

As seen in Table IV, the rubber chemistries are generally similar for the initiators. Of interest however, are the relatively high grafting or gel/rubber values obtained with the tetrafunctional peroxide. These results indicate that “normal” rubber phase properties are attainable at high polymerization rates with PERKADOX 12-AT25.

It may also be seen in Table IV, in Examples 17 and 18 using a tetrafunctional initiator, that as the swell index increased from 11.0 to 14.3, the ratio of % gel/% rubber increased from 2.76 (26.8/9.7 for Example 17) to 2.84 (23.9/8.4 for Example 18). This trend follows an increase in the PERKADOX 12-AT25 concentration.

TABLE IV
Effect of Initiators on HIPS Properties

| Ex. | [I] ppm | Initiator | G/R Ratio | SI | RPS (vol. med., μ) |
|---|---|---|---|---|---|
| 13 | 152 | L331 | 2.4 | 12.3 | 1.51 |
| 14 | 303 | L331 | 2.8 | 8.7 | 2.44 |
| 15 | 168 | L531 | 2.8 | 8.7 | 2.61 |
| 16 | 335 | L531 | 2.6 | 9.6 | 3.05 |
| 17 | 163 | P12 | 2.8 | 11.0 | 1.34 |
| 18 | 326 | P12 | 2.8 | 14.3 | 2.25 |
| 19 | 134 | T42S | 2.4 | 9.9 | 1.19 |
| 20 | 268 | T42S | 2.9 | 8.8 | 1.96 |

NOTES:
1. SI is swell index.
2. RPS is volume median rubber particle size measured by a Malvern Analyzer in methyl ethyl ketone.
3. A grafting percent can be obtained as follows: % grafting = 100 (% gels − % rubber)/% rubber. This is the same as 100 (G/R − 1).

Molecular Weight Stability Studies

Previous laboratory studies showed that polystyrene produced via peroxide initiation exhibited similar levels of thermal degradation (i.e., chain scission) to those of thermally polymerized polystyrene. Further work was conducted to compare the thermal stability of polymers prepared with a bifunctional initiator (168 LUPERSOL 531) to that of polystyrene prepared with the tetrafunctional initiator (163 and 326 ppm PERKADOX 12-AT25).

The samples were heated isothermally at 270 C for 1 hour in a differential scanning calorimeter (DSC). Molecular weights were then obtained via gel permeation chromatograph (GPC). The results are summarized in Table V.

TABLE V
Effects of Heat Treatment on Molecular Weight

| | | | | % Mw | | % Mn |
|---|---|---|---|---|---|---|
| Ex. | [I] ppm | Initiator | Mw/1000 | Decrease | Mn/1000 | Decrease |
| 21 | 168 | L531 | 263 | — | 116 | — |
| 22 | 168 | L531-H | 224 | 14.8 | 92 | 20.7 |
| 23 | 163 | P12 | 309 | — | 112 | — |
| 24 | 163 | P12-H | 240 | 22.3 | 80 | 28.6 |
| 25 | 326 | P12 | 314 | — | 82 | — |
| 26 | 326 | P12-H | 282 | 10.2 | 77 | 6.1 |

NOTE:
The “-H” designation indicates after heat treatment.

As seen from Table V, the molecular weight decreases after heat treatment ranged from 10-22% for Mw and 6-29% for Mn. The degree of thermal degradation for the tetrafunctional initiator-produced PS was within the general range for that of the bifunctional initiator-produced PS.

It may be concluded that:
The utility of monofunctional initiators is limited in terms of increasing polymerization productivity due to kinetic constraints.
Bi- or multifunctional initiators offer superior rate/molecular weight relationships.
The developmental tetrafunctional initiator (e.g. PERKADOX 12) yielded significantly higher polymerization rates and molecular weights (particularly Mw) than did LUPERSOL 331 or 531.
   It is apparent that proper selection and usage of bi- or multifunctional initiators may yield the optimum balance of polymerization rate and molecular weight.
   Improvement of Rubber Phase Volume of HIPS

It has been discovered that tetrafunctional initiators, such as alkylperoxycarbonates, for instance JWEB50 tetra t-butylperoxycarbonate available from ATOFINA Petrochemicals, Inc., can be used to improve the rubber phase volume of HIPS products, as measured by the ratio of % gels/% rubber.

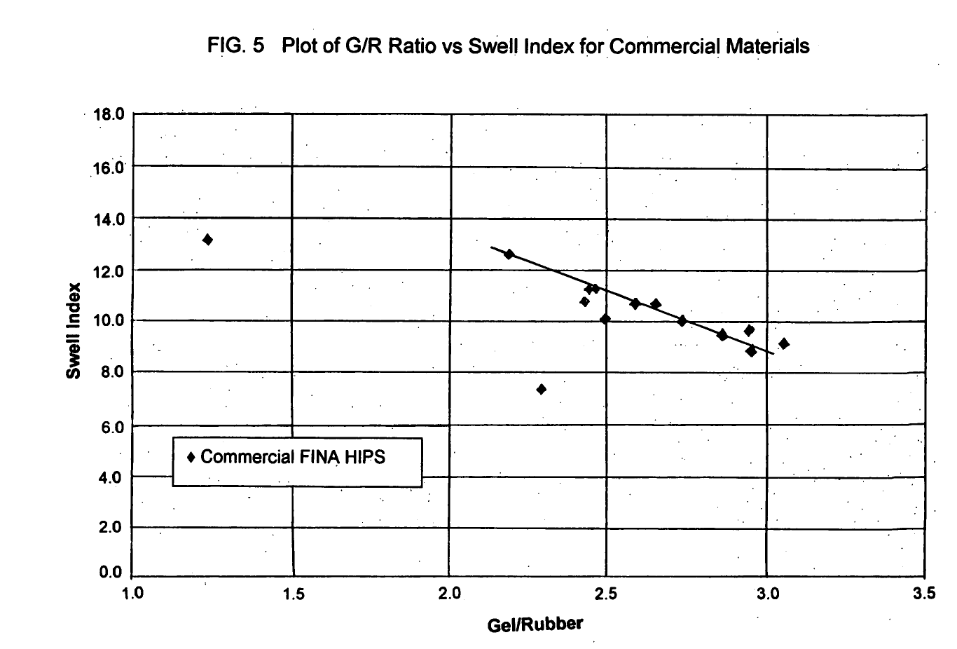

FIG. 5 shows the relationship of % gels/% rubber vs. swell index for commercial products. The % gels was used a measure of rubber phase volume and was measured by dissolving HIPS in toluene, separating the insoluble gel phase by centrifugation and then reporting the % of insoluble gel of the total sample. Swell index (SI) is measured in the same experiment. After separating the insoluble gel phase by centrifugation, the swollen gel is weighed, dried under vacuum and then the weight of the dry gel is obtained. The swell index is the ratio of the weight of swollen gel to dry gel, and it is a measure of the degree of cross-linking of the rubber phase.

It is well known that the impact properties of HIPS are determined by the properties of the rubber phase volume; thus, an improvement in the % gel/% rubber ratio (G/R) is highly desirable.

FIG. 5 shows that some commercial resins have a G/R of 2.2-3.0 at a swell index of 13-9. Note particularly that as the swell index increases the G/R decreases. In one non-limiting explanation, this may be because at higher swell indices the solvent expands the rubber network more and the polystyrene that is trapped inside migrates or diffuses out of the rubber particles, which leads to lower gel values.

Table VI shows the data obtained as the level of tetrafunctional initiator is increased. Batch syntheses were carried out isothermally at 127° C.

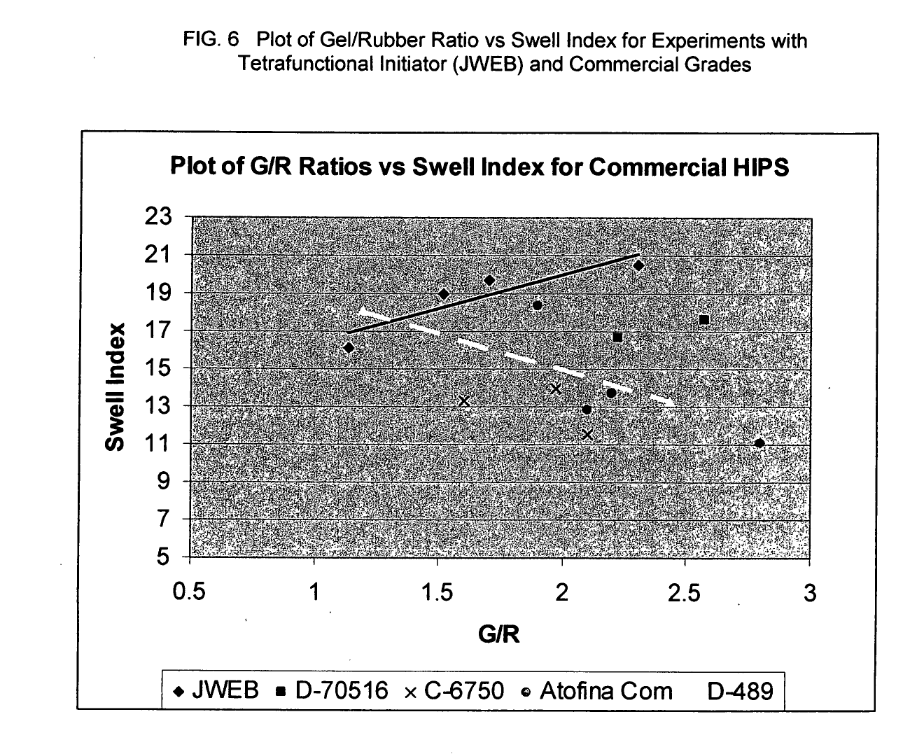

FIG. 6 compares the results of Examples 27, 28, 29 and 30 of this invention with some of the commercial grades from FIG. 5. It may be noted that JWEB50 shows a surprising, opposing trend that as the level of JWEB50 is increased, the G/R ratio increases, even though the swell index of these materials is very high. The trend of the commercial materials is indicated by the lighter dashed descending line, and this is the trend commonly observed. The trend shown by the darker, ascending line for JWEB50 is surprising and quite unique. Without wishing to be bound to any particular explanation, it is not clear if this effect is due to the potential for forming branched structures exhibited by multifunctional initiators. The extent of branching can be measured by the Theological technique used in L. Kasehagen, et al., “A New Multifunctional Peroxide Initiator for High Molecular Weight, High Productivity, and Long-Chain Branching,” Society of Plastics Engineering, ANTEC, Paper 99, 2000, incorporated by reference herein.

TABLE VI
Effect of JWEB on G/R Ratio

| | Formulation, | | |
|---|---|---|---|
| Ex. | ppm JWEB50 | Swell Index | Gel/Rubber |
| 27 | 0 | 16.1 | 1.14 |
| 28 | 200 | 19.0 | 1.52 |
| 29 | 400 | 19.7 | 1.70 |
| 30 | 600 | 20.5 | 2.30 |

The resins of this invention are expected to produce HIPS with higher rubber efficiencies, improved impact strength and ductility.

The styrene-based polymers of the present invention are expected to find use in other injection molded or extrusion molded articles. Thus, the styrene-based polymers of the present invention may be widely and effectively used as materials for injection molding, extrusion molding or sheet molding. It is also expected that the polymer resins of this invention can be used as molding material in the fields of various different products, including, but not necessarily limited to, household goods, electrical appliances and the like.

In the foregoing specification, the invention has been described with reference to specific embodiments thereof, and has been demonstrated as effective in providing methods for preparing polymers using multifunctional peroxide initiators. However, it will be evident that various modifications and changes can be made thereto without departing from the scope of the invention as set forth in the appended claims. Accordingly, the specification is to be regarded in an illustrative rather than a restrictive sense. For example, specific combinations or amounts of vinylaromatic monomers, diene polymers, multifunctional peroxide initiators, and other components falling within the claimed parameters, but not specifically identified or tried in a particular polymer system, are anticipated and expected to be within the scope of this invention. Further, the methods of the invention are expected to work at other conditions, particularly temperature, pressure and proportion conditions, than those exemplified herein.

1. A method for producing an improved copolymerized product comprising:
copolymerizing at least one vinylaromatic monomer with at least one diene polymer in the presence of at least one multifunctional initiator selected from the group consisting of trifunctional and tetrafunctional peroxides, and
recovering a copolymerized product that has a ratio of % gel to % rubber (G/R) that increases as swell index increases.

2. The method of claim 1 where the copolymerized product has a melt flow index (MFI) ranging from about 2 to about 7.

3. The method of claim 1 where the G/R increases from about 1 to about 4 as the swell index increases from about 8 to about 20.

4. The method of claim 1 where in copolymerizing the monomer, the vinylaromatic monomer is styrene.

5. The method of claim 1 where in copolymerizing the monomer, the multifunctional initiator is selected from the group consisting of tri- or tetakis t-alkylperoxycarbonates, tri- or tetrakis(polyether peroxycarbonate), tri- or tetrakis-t-butylperoxycarbonyloxy) methane, tri- or tetrakis-(t-butylperoxycarbonyloxy)butane, tri- or tetrakis(t-amylperoxycarbonyloxy)butane and tri- or tetrakis(t-C₄₋₆ alkyl monoperoxycarbonates), and mixtures thereof.

6. The method of claim 1 where the copolymerized product is more highly branched as compared with a polymerized product made by an otherwise identical method except that a multifunctional initiator replaces at least a portion of a difunctional initiator.

7. The method of claim 1 where the multifunctional initiator is present in an amount ranging from about 50 to about 1200 ppm, based on the vinylaromatic monomer.

8. The method of claim 1 where in copolymerizing the monomer, the polymerizing is conducted at a temperature between about 110° C. and about 180° C.

9. The method of claim 1 where the weight ratio of vinylaromatic monomer to diene polymer ranges from about 97:3 to about 85:15.

10. The method of claim 1 where in recovering the product, the copolymerized product is high impact polystyrene (HIPS).

11. The method of claim 1 where the polymerization rate ranges from about 2 to 7 times that of styrene polymerized thermally in the absence of initiator.

12. The method of claim 1 where the polydispersity of the copolymerized product ranges from about 2.3 to about 4.0.

13. An improved copolymerized product made by the process comprising:
copolymerizing at least one vinylaromatic monomer with at least one diene polymer in the presence of at least one multifunctional initiator selected from the group consisting of trifunctional and tetrafunctional peroxides, and
recovering a copolymerized product that has a ratio of % gel to % rubber (G/R) that increases as swell index increases.

14. The copolymerized product of claim 13 where the copolymerized product has a melt flow index (MFI) ranging from about 2 to about 7.

15. The copolymerized product of claim 13 where the G/R increases from about 1 to about 4 as the swell index increases from about 8 to about 20.

16. The copolymerized product of claim 13 where in copolymerizing the monomer, the vinylaromatic monomer is styrene.

17. The copolymerized product of claim 13 where in copolymerizing the monomer, the multifunctional initiator is selected from the group consisting of tri- or tetrakis t-alkylperoxycarbonates, tri- or tetrakis(polyether peroxycarbonate), tri- or tetrakis-(t-butylperoxycarbonyloxy)methane, tri- or tetrakis-(t-butylperoxycarbonyloxy) butane, tri- or tetrakis(t-amylperoxycarbonyloxy)butane and tri- or tetrakis(t-C₄₋₆ alkyl monoperoxycarbonates), and mixtures thereof.

18. The copolymerized product of claim 13 where in recovering the copolymerized product, the product is more highly branched as compared with a polymerized product made by an otherwise identical method except that a multifunctional initiator replaces at least a portion of a difunctional initiator.

19. The copolymerized product of claim 13 where in the copolymerizing the multifunctional initiator is present in an amount ranging from about 50 to about 1200 ppm, based on the vinylaromatic monomer.

20. The copolymerized product of claim 13 where in the copolymerizing the polymerization rate ranges from about 2 to 7 times that of styrene polymerized thermally in the absence of initiator.

21. The copolymerized product of claim 13 where the polydispersity of the copolymerized product ranges from about 2.3 to about 4.0.

22. The copolymerized product of claim 13 where in copolymerizing the monomer, the polymerizing is conducted at a temperature between about 110° C. and about 180° C.

23. The copolymerized product of claim 13 where in copolymerizing the monomer, the weight ratio of vinylaromatic monomer to diene polymer ranges from about 97:3 to about 85:15.

24. The copolymerized product of claim 13 where in recovering the product, the polymerized product is high impact polystyrene (HIPS).

25. An article made with the vinylaromatic/diene graft copolymer of claim 13.

26. A resin comprising:
at least one vinylaromatic monomer;
at least one diene polymer;
at least one multifunctional initiator selected from the group consisting of trifunctional and tetrafunctional peroxides, where the amount of multifunctional initiator is sufficient to produce a copolymerized product that has a % gel to % rubber (G/R) ratio that increases as swell index increases.

27. The resin of claim 26 where the amount of multifunctional initiator is sufficient to polymerize the vinylaromatic monomer at a rate of from about 2 to 7 times that of styrene polymerized thermally in the absence of initiator.

28. The resin of claim 26 where the amount of multifunctional initiator is sufficient to produce a copolymerized product having a polydispersity ranging from about 2.3 to about 4.0.

29. The resin of claim 26 where the amount of multifunctional initiator is sufficient to produce a copolymerized product that has a melt flow index (MFI) ranging from about 2 to about 7.

30. The resin of claim 26 where the G/R increases from about 1 to about 4 as the swell index of the product made therefrom increases from about 8 to about 20.

31. The resin of claim 26 where the vinylaromatic monomer is styrene.

32. The resin of claim 26 where the multifunctional initiator is selected from the group consisting of tri- or tetrakis t-alkylperoxycarbonates, tri- or tetrakis (polyether peroxycarbonate), tri- or tetrakis-(t-butylperoxycarbonyloxy)methane, tri- or tetrakis-(t-butylperoxycarbonyloxy)butane, tri- or tetrakis(t-amylperoxycarbonyloxy) butane and tri- or tetrakis(t-C₄₋₆ alkyl monoperoxycarbonates), and mixtures thereof.

33. The resin of claim 26 where the copolymerized product made therefrom is more highly branched as compared with a polymerized product made by an otherwise identical method except that a multifunctional initiator replaces at least a portion of a difunctional initiator.

34. The resin of claim 26 where in the multifunctional initiator is present in an amount ranging from about 50 to about 1200 ppm, based on the vinylaromatic monomer.

35. The resin of claim 26 where the weight ratio of vinylaromatic monomer to diene polymer ranges from about 97:3 to about 85:15.

36. An article made from the resin of claim 26.
